(19) United States
(12) Patent Application Publication
(10) Pub. No.: US 2009/0071912 A1
(43) Pub. Date: Mar. 19, 2009

(54) DEVICE AND METHOD FOR REMOVING LINT

(76) Inventors: Takashi Mishina, Yamanashi (JP); Yasunori Atsumi, Yamanashi (JP); Harutoshi Shimoyama, Yamanashi (JP); Yuichi Kanoh, Yamanashi (JP)

Correspondence Address: FOLEY AND LARDNER LLP;SUITE 500, 3000 K STREET NW, WASHINGTON, DC, 20007, US

(21) Appl. No.: 11/915,063

(22) PCT Filed: May 22, 2006
(86) PCT No.: PCT/JP2006/310129

§ 371 Date: Jan. 23, 2008

(51) Int. Cl. C02F 1/00; B01D 35/22

(52) U.S. Cl. 210/791; 210/171; 210/805

(57) ABSTRACT

[PROBLEMS] To provide a device and a method for automatically removing lint without requiring special skill and labor by improving a lint removal technique in a continuous washing machine. [MEANS FOR SOLVING PROBLEMS] An opening (2a) is formed in a washing liquid feed tube (2), and a guide vane (6) is fixed to the feed tube along the opening (2a). A cylindrical screen (3) is fitted onto the feed tube rotatably about the feed tube (2), and rotatingly driven by rotating drive rollers (7a) and (7b). A washing liquid flowing out of the opening (2a) is passed through the side wall (3a) of the cylindrical screen (3), filtrated to separate the lint from the washing liquid, and recirculated from a collecting tube (5) to the continuous washing machine. When the cylindrical screen (3) is rotated, the lint deposited on the inner peripheral surface of the side wall (3a) thereof is peeled off by a liquid flow led thereto by the guide vane (6), lowered due to a difference in specific gravity, led to a lint outlet (3c), and automatically discharged to the outside.

### TECHNICAL FIELD

The present invention relates to a technique to easily and automatically remove lint contained in a washing liquid in a continuous washing machine. In the present invention, the term “washing liquid” is herein used as a generic term for liquid used for washing including prewashing liquid and rinsing liquid.

### BACKGROUND ART

In a continuous washing machine which generally agitates textile laundry in a washing liquid, lint (or little pieces of thread) gets mixed in the washing liquid as the washing process proceeds. Conventionally, various techniques to remove lint have been developed, one of which is filtration using a screen (or a filter). The prior art employs a screen as a static member such that lint is filtrated off a liquid when the liquid crosses the screen.

For example, Japanese Patent Laid-Open No. 10-033882 discloses a collecting apparatus in which an opening is disposed so as to face obliquely upward. Also, Japanese Patent Laid-Open No. 09-299685 discloses a technique to equip a filter in such a way that the filter does not hinder the laundry. Furthermore, Japanese Patent Laid-Open No. 07-088309 discloses an improved marquisette knitting employing an innovative way of weaving filter fabric. Japanese Patent Laid-Open No. 2005-192920 discloses a technique to remove lint using a comb-like member.

Conventionally, various efforts have been made in how to filtrate off lint more efficiently. As the washing process proceeds, however, filtrated lint is collected on a screen and the resistance of the screen to the liquid flow rises. The lint collected on a screen has usually been removed by hand. Removal of lint thus required a lot of time and labor.

### DISCLOSURE OF THE INVENTION

### Problems to be Solved by the Invention

In view of the problems of prior art as mentioned above, it is an object of the present invention to provide a novel technique to enable automatic removal of lint collected on a screen, thereby contributing to automation of washing process and lavorsaving of maintenance of washing machines.

### Means for Solving the Problems

The invention as claimed in claim 1 provides a lint removing apparatus comprising:

a washing liquid supplying pipe having an opening on the peripheral wall thereof;
a tubular screen disposed coaxially with said washing liquid supplying pipe so as to accommodate said washing liquid supplying pipe, said tubular screen being rotatable with respect to said washing liquid supplying pipe; and
a drive means to rotate said tubular screen.

The invention as claimed in claim 2 provides a lint removing apparatus for a continuous washing machine comprising:

a washing liquid supplying pipe having an opening on the peripheral wall thereof;
a cylindrical screen disposed coaxially with said washing liquid supplying pipe so as to accommodate said washing liquid supplying pipe, said cylindrical screen being rotatable with respect to said washing liquid supplying pipe; and
a drive means to rotate said cylindrical screen, wherein said tubular screen is a cylindrical screen having a guide wing attached to said washing liquid supplying pipe adjacent to said opening, said guide wing having an end extending toward the inner peripheral wall of said cylindrical screen such that said end is disposed adjacent to the inner peripheral wall of said cylindrical screen;
said lint removing apparatus further comprising a screen case accommodating said cylindrical screen and communicated with a washing liquid collecting pipe.

The invention as claimed in claim 3 provides the lint removing apparatus for a continuous washing machine as set forth in claim 2, wherein

said washing liquid supplying pipe is formed to be elongated in the axial direction of said cylindrical screen, and
the length of said opening in said axial direction is substantially same as the length of said cylindrical screen.

The invention as claimed in claim 4 provides the lint removing apparatus for a continuous washing machine as set forth in claim 3, wherein

said washing liquid supplying pipe is a static member, and
said opening of said washing liquid supplying pipe is formed on the condition that:
a. when polar coordinates are assumed on the cross section of said washing liquid supplying pipe in which the polar angle of the vertically upward radius is defined as 0 degree,
b. the positive direction of the polar angle is defined to be opposite to the rotating direction of said cylindrical screen,
c. the polar angular position of said opening is from 0 degree to 180 degree.

The invention as claimed in claim 5 provides the lint removing apparatus for a continuous washing machine as set forth in claim 4, wherein

said guide wing attached to said washing liquid supplying pipe is a static member, and
the polar angular position of the end of said guide wing is from 0 degree to 180 degree in said polar coordinates.

The invention as claimed in claim 6 provides the lint removing apparatus for a continuous washing machine as set forth in claim 5, wherein

said cylindrical screen is formed in a substantially cylindrical shape and has a peripheral wall made of a porous plate, a wedge wire member or other similar member.

The invention as claimed in claim 7 provides the lint removing apparatus for a continuous washing machine as set forth in claim 6, wherein

said cylindrical screen formed in a substantially cylindrical shape has an end wall made of a cover plate and another end wall having a lint outlet.

The invention as claimed in claim 8 provides the lint removing apparatus for a continuous washing machine as set forth in claim 7, wherein

said cylindrical screen is inclined such that said lint outlet is disposed on the lower position.

The invention as claimed in claim 9 provides the lint removing apparatus for a continuous washing machine as set forth in claim 1, wherein

a screw conveyer is disposed in said cylindrical screen.

The invention as claimed in claim 10 provides the lint removing apparatus for a continuous washing machine as set forth in claim 9, wherein

said screw conveyer is mounted on said washing liquid supplying pipe in a coaxial position with respect to said washing liquid supplying pipe, and
a washing liquid outlet is formed in the vicinity of an end of said washing liquid supplying pipe.

The invention as claimed in claim 11 provides the lint removing apparatus for a continuous washing machine as set forth in claim 10, wherein

said cylindrical screen has a peripheral wall formed with wedge wire, the cross angle between the strand of said wedge wire and the circumferential direction of said cylindrical screen being 0 degree<θ≦90 degree.

The invention as claimed in claim 12 provides the lint removing apparatus for a continuous washing machine as set forth in claim 10, wherein

said cylindrical screen has a peripheral wall formed with numerous arranged pores.

The invention as claimed in claim 13 provides the lint removing apparatus for a continuous washing machine as set forth in claim 12, wherein

said wedge wire or said pores are disposed on part of said cylindrical screen on the side of the end of said cylindrical screen accommodating said washing liquid supplying pipe, and
part of said cylindrical screen on the side of the open end thereof is impermeable, which is between said open end and a cross sectional plane S of said cylindrical screen at a distance P from said washing liquid outlet toward said open end.

The invention as claimed in claim 14 provides the lint removing apparatus for a continuous washing machine as set forth in claim 11, wherein

said washing liquid supplying pipe is formed with a washing liquid diffuser plate in the vicinity of said washing liquid outlet and on the side closer to said open end of said cylindrical screen so as to diffuse washing liquid radially outward.

The invention as claimed in claim 15 provides the lint removing apparatus for a continuous washing machine as set forth in claim 13, wherein

said washing liquid supplying pipe is formed with a washing liquid diffuser plate in the vicinity of said washing liquid outlet and on the side closer to said open end of said cylindrical screen so as to diffuse washing liquid radially outward.

The invention as claimed in claim 16 provides the lint removing apparatus for a continuous washing machine as set forth in claim 1, wherein

said cylindrical screen is a conical-cylindrical screen formed in the shape of a conical cylinder having a peripheral wall made of filter and an open bottom end; said lint removing apparatus further comprising a drive means to rotate said conical-cylindrical screen and
a washing liquid supplying pore formed on the side of smaller end of said conical-cylindrical screen.

The invention as claimed in claim 17 provides the lint removing apparatus for a continuous washing machine as set forth in claim 16, wherein

said conical-cylindrical screen is formed with a washing liquid diffuser plate substantially perpendicular thereto in a position closer to said bottom end relative to the position of said washing liquid supplying pore inside said conical-cylindrical screen.

The invention as claimed in claim 18 provides the lint removing apparatus for a continuous washing machine as set forth in claim 17, wherein

said conical-cylindrical screen is formed in the shape of a truncated cone, said truncated top being covered with a panel,
said washing liquid supplying pipe is disposed to penetrate said panel so as to be rotatable relative to said panel, and
said washing liquid supplying pipe is formed with a washing liquid supplying pore on an end thereof.

The invention as claimed in claim 19 provides the lint removing apparatus for a continuous washing machine as set forth in claim 17, wherein

said drive means to rotate said conical-cylindrical screen consists of an outer rolling surface on a larger end of said conical-cylindrical screen, a pulley having the same radius as said outer rolling surface disposed on a smaller end of said conical-cylindrical screen and driving rollers contacting with both said outer rolling surface and said pulley.

The invention as claimed in claim 20 provides a method for removing lint from washing liquid comprising the steps of:

allowing washing liquid supplied by an washing liquid supplying pipe to be let out through an opening formed on the peripheral wall of said washing liquid supplying pipe;
introducing the washing liquid into the inside of a tubular screen accommodating said washing liquid supplying pipe such that lint is filtered off said washing liquid when crossing the peripheral wall of said tubular screen; and
recycling into a washing machine the clean washing liquid having lint filtered off by rotating said tubular screen with respect to the axis of said washing liquid supplying pipe.

The invention as claimed in claim 21 provides the method for removing lint from washing liquid for a continuous washing machine as set forth in claim 20, wherein

said tubular screen is a cylindrical screen, and
lint collected on the inner peripheral wall of said cylindrical screen is automatically removed by liquid flow generated by a guide wing mounted on said washing liquid supplying pipe.

The invention as claimed in claim 22 provides the method for removing lint from washing liquid for a continuous washing machine as set forth in claim 21, wherein

said cylindrical screen is disposed to be inclined such that lint removed by said liquid flow is moved to the lower side thereof so as to be discharged through a lint outlet formed on the lower side end of said cylindrical screen.

The invention as claimed in claim 23 provides the method for removing lint from washing liquid as set forth in claim 20, wherein

said tubular screen is a cylindrical screen having an open end and a screw conveyer therein, and
lint collected on the inner peripheral wall of said cylindrical screen is discharged through the open end thereof by
allowing washing liquid to be let out in said cylindrical screen in the vicinity of the other end than said open end thereof,
allowing washing liquid to cross the peripheral wall of said cylindrical screen such that lint is filtered off the washing liquid, and
rotating said cylindrical screen around the axis thereof to cause said screw conveyer to convey said collected lint toward the open end of said cylindrical screen.

The invention as claimed in claim 24 provides the method for removing lint from washing liquid as set forth in claim 23, wherein

a washing liquid diffuser plate is disposed in the vicinity of the washing liquid outlet inside said cylindrical screen so as to diffuse the washing liquid let out into said cylindrical screen in radially outward direction of said cylindrical screen.

The invention as claimed in claim 25 provides the method for removing lint from washing liquid as set forth in claim 24, wherein

said cylindrical screen is at least partially formed with wedge wire and permeable, and
the cross angle between the strand of said wedge wire and the circumferential direction of said cylindrical screen being 0 degree<0≦90 degree, or wherein
the peripheral wall of said cylindrical screen is at least partially formed with pores so as to function as a permeable filter, and
part of said cylindrical screen on the side closer to the open end thereof is not formed with wedge wire or pores and is impermeable, which is between said open end and a cross sectional plane S of said cylindrical screen at a distance P from said washing liquid outlet toward said open end.

The invention as claimed in claim 26 provides the method for removing lint from washing liquid as set forth in claim 20, wherein

said cylindrical screen is a conical-cylindrical screen having an open bottom end, and
lint is automatically discharged through said open bottom end thereof by supplying washing liquid to the side of the top of the corn of said conical-cylindrical screen with said conical-cylindrical screen being rotated around the axis X thereof so as to cause the supplied washing liquid to flow in the rotating direction and to be centrifugally forced to cross through the peripheral wall of said conical-cylindrical screen with the lint filtered off, the filtered lint collected on the inner peripheral wall of said conical-cylindrical screen being centrifugally forced to move toward the bottom end thereof.

The invention as claimed in claim 27 provides the method for removing lint from washing liquid as set forth in claim 26, wherein

a washing liquid diffuser plate is disposed in a position closer to said bottom end relative to the position of the washing liquid supplying opening inside said conical-cylindrical screen so as to diffuse the washing liquid toward the inner peripheral wall of said conical-cylindrical screen.

The invention as claimed in claim 28 provides the method for removing lint from washing liquid as set forth in claim 27, wherein

said conical-cylindrical screen is formed with an outer rolling surface on the larger end thereof to be contacted with driving rollers and a pulley having the same radius as said outer rolling surface on the smaller thereof to be contacted with said driving rollers such that said conical-cylindrical screen is driven to rotate.

The invention as claimed in claim 29 provides the method for removing lint from washing liquid as set forth in claim 28, wherein

the peripheral wall of said conical-cylindrical screen is formed with wedge filter, and
the angle φmade by the wedge wire of said wedge filter and the circumference passing through a point P on the peripheral surface of said conical-cylindrical screen is 0 degree≦φ<90 degree,
or wherein
the peripheral wall of said conical-cylindrical screen is formed with numerous pores.

### EFFECTS OF THE INVENTION

By employing the apparatus according to the present invention, it will be possible to efficiently filter off lint and to automatically eject the lint filtered off, without necessitating cleaning by hand. Furthermore, it will be possible to put a washing process on a faster track because no special skill and labor is required.

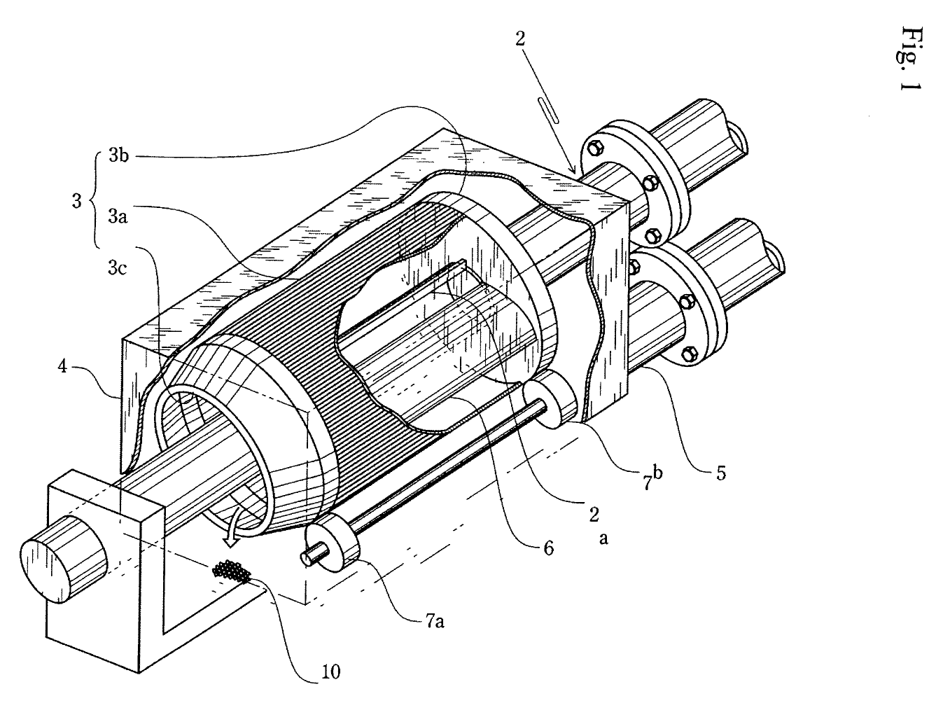

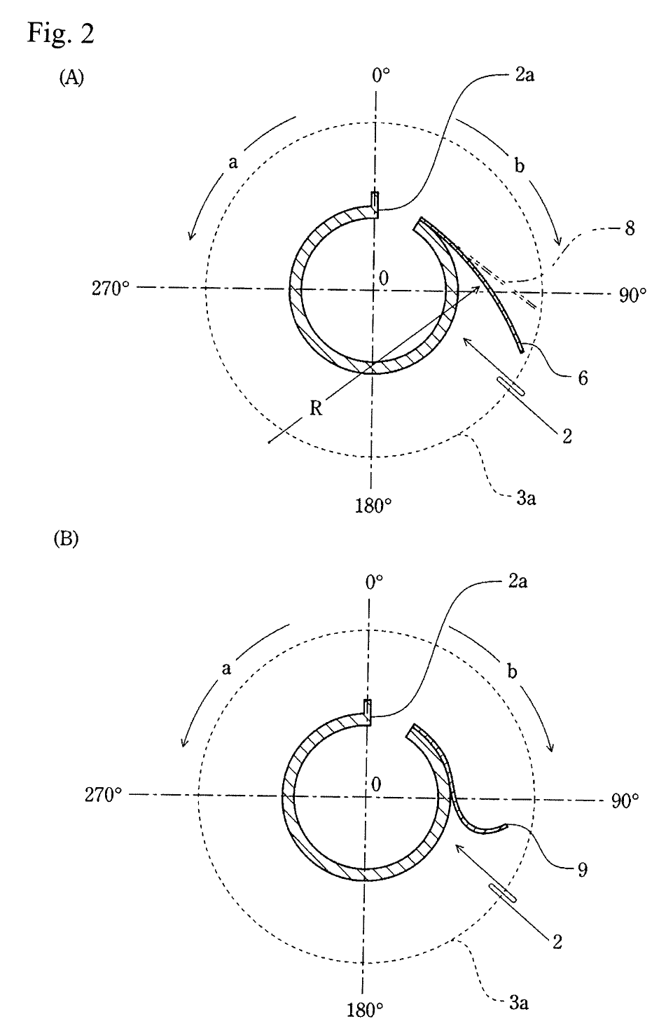

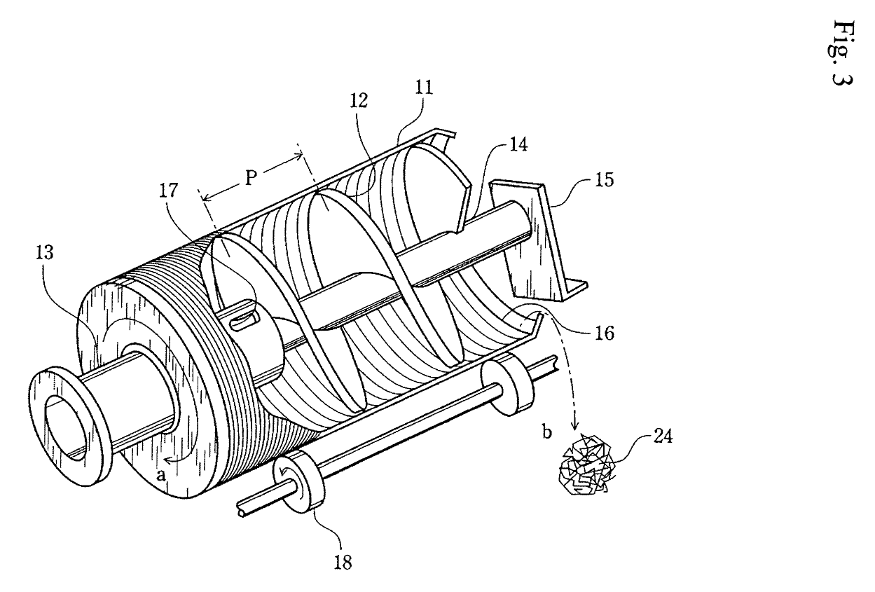

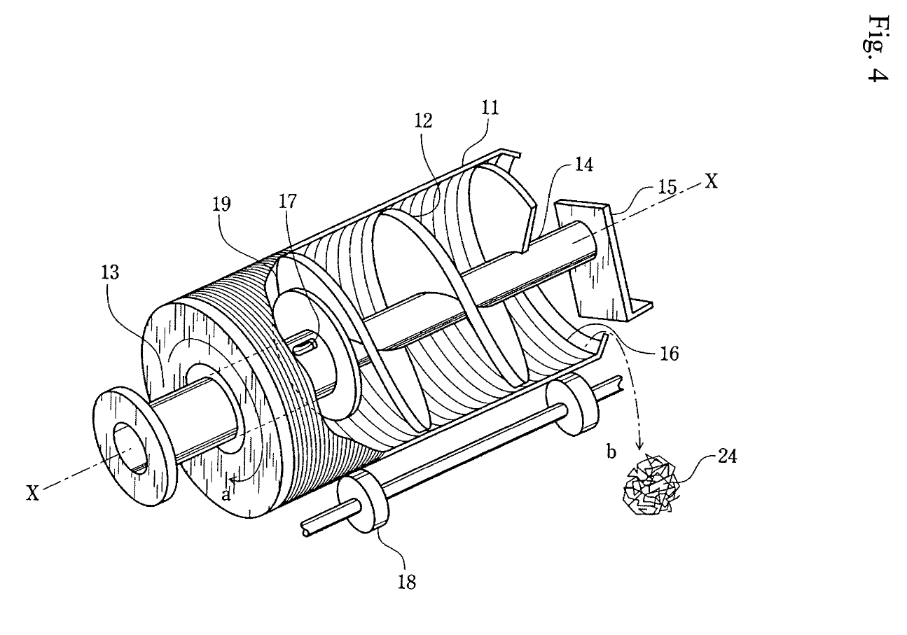

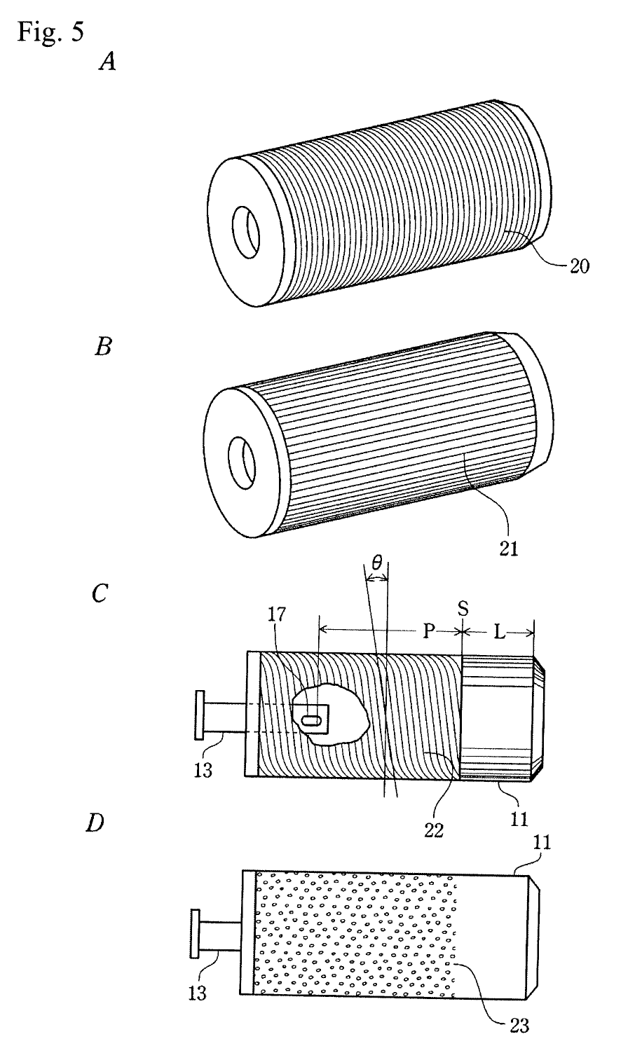

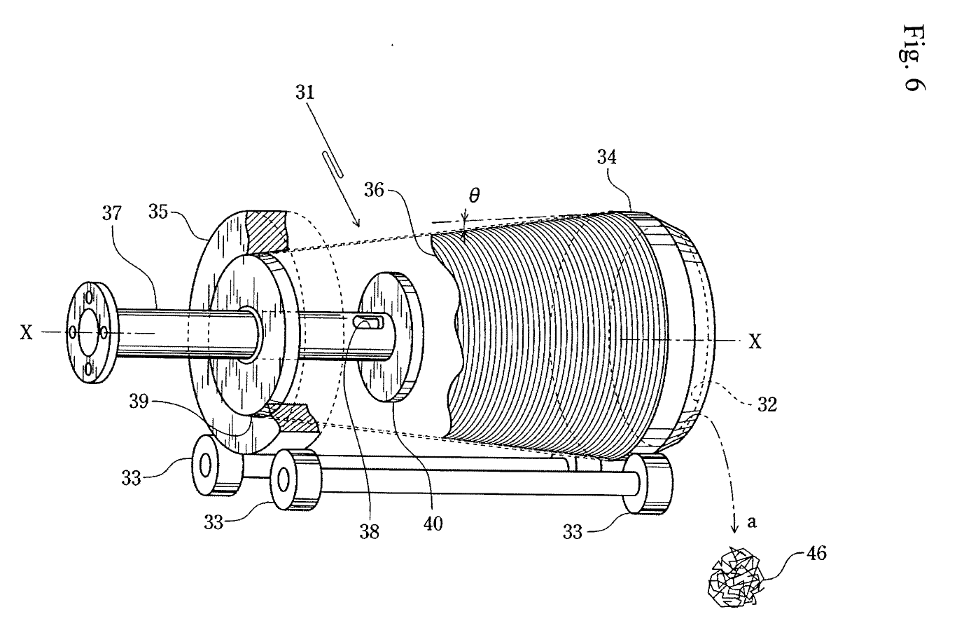

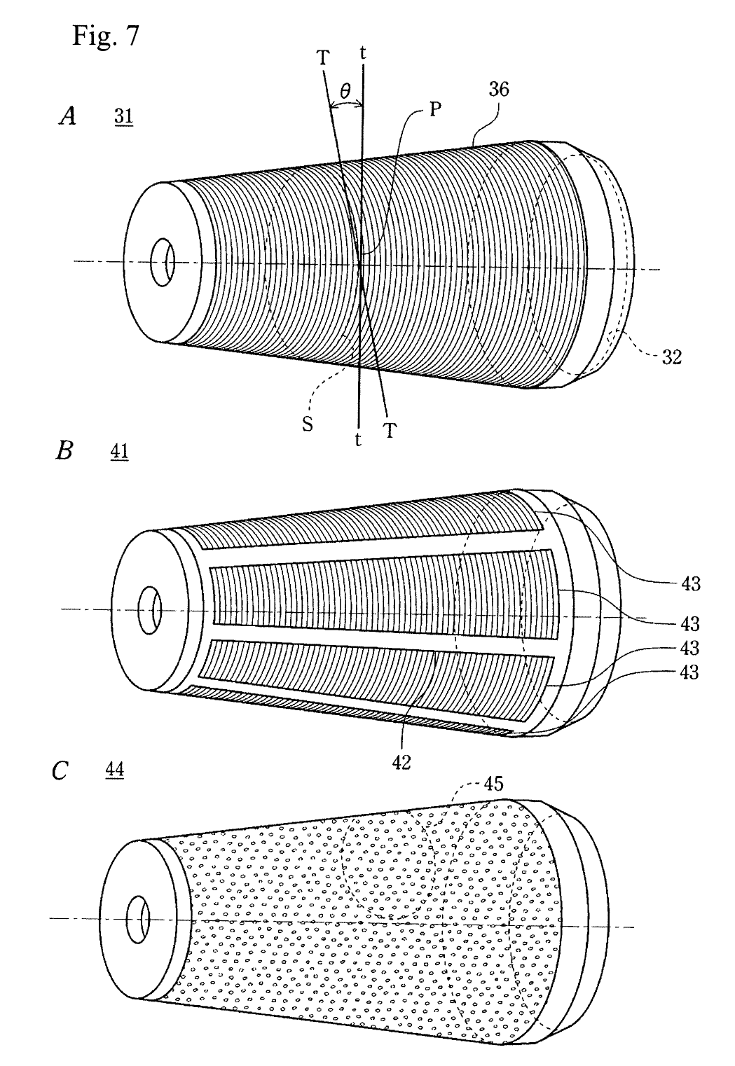

### BRIEF DESCRIPTION OF THE DRAWINGS

[FIG. 1] A perspective outline view of an apparatus according to the first embodiment of the present invention.

[FIG. 2] (A) shows, in polar coordinates, atypical view of a cross section of a washing liquid supplying pipe, a guide wing and a cylindrical screen in the embodiment shown in FIG. 1; (B) shows, in polar coordinates, a typical view of a cross section in an embodiment other than the above.

[FIG. 3] A perspective view of an apparatus according to the second embodiment of the present invention.

[FIG. 4] A perspective view of an apparatus according to another embodiment of the present invention.

[FIG. 5] An outline view exemplifying four different variations of cylindrical screen.

[FIG. 6] A perspective view of an apparatus according to the third embodiment of the present invention.

[FIG. 7] Views showing various examples of conical conical-cylindrical screen according to the present invention; (A) showing an example of a filter wound with wedge wire, (B) showing an example of a framed structure fit with a plurality of filter segments, and (C) showing an example of a punching plate formed with numerous pores which is made by sheet metal processing.

### BEST MODE FOR CARRYING OUT THE INVENTION

Best mode for carrying out the present invention will be below explained by exemplifying a first embodiment, a second embodiment and a third embodiment of the present invention.

### First Embodiment

FIG. 1 is a partially broken perspective outline view showing an embodiment of the lint removing apparatus according to the present invention. This Figure shows a typical view and does not show a realistic view. Washing liquid is supplied by a washing liquid supplying pipe 2 so as to be let out through an opening 2a. The dimension of the opening 2a is so designed as to control the rate of flow therethrough. A cylindrical screen 3 is disposed to accommodate said opening 2a. The opening 2a extends in the axial direction such that most part of the washing liquid supplying pipe accommodated in the cylindrical screen is open, thereby allowing the liquid flow to be equal in the axial direction.

The cylindrical screen 3 is rotatably supported around the axis of the washing liquid supplying pipe 2 and is rotated by driving rollers 7a and 7b (the direction of rotation will be explained below with reference to FIG. 2). The cylindrical screen 3 has a peripheral wall 3a, and a cover plate 3b and a lint outlet 3c disposed on the sides thereof.

A screen case 4 is disposed to accommodate the rotating member consisting of the cylindrical screen 3 and rollers 7a and 7b. The screen case 4 is made watertight because washing liquid is supplied out of the opening 2a. Although not shown in the Figs., the screen case 4 has an observation window. Although the washing liquid supplying pipe 2 penetrates through the screen case 4 causes, there is no difficulty in making the screen case 4 watertight because both the washing liquid supplying pipe 2 and the screen case 4 do not rotate.

The peripheral wall 3a of the cylindrical screen 3 is made of a porous plate, wedge wire or other similar filtering material. Washing liquid let out from the opening 2a crosses the peripheral wall 3a into the inside of the screen case 4 and into a recycling pipe 5 so as to be recycled into a washing tank (not shown). When washing liquid crosses the peripheral wall 3a, lint contained in the washing liquid is filtered off to be collected on the peripheral wall 3a of the cylindrical screen 3 such that clean washing liquid cleared of lint is recycled.

A guide wing 6 is mounted on the washing liquid supplying pipe 2. The guide wing is disposed inside the screen case 4 along with the opening 2a. The end of the guide wing 6 confronts the inner peripheral wall 3a in the vicinity thereof. Lint filtered off by the peripheral wall 3a adheres thereto. The guide wing 6 allows washing liquid let out of the opening 2a to be blasted onto the inner peripheral wall 3a to remove lint adhered thereto. The cylindrical screen 3 is rotated such that lint adhered to the inner peripheral wall 3a is removed evenly.

The axis of the cylindrical screen 3 is inclined relative to the horizontal line such that the lint outlet 3c is arranged on the lower side. This allows lint removed by the liquid flow made by the guide wing 6 moves downward because of its higher gravity and to be let out through the lint outlet 3c as lint balls 10. The washing operation can be continued because lint (lint balls 10) let out of the lint outlet 3c and into the screen case 4 does not cause trouble for washing operation. Lint balls 10 accumulated in the screen case 4 can be visually observed through an inspection window thereon may be removed and discarded when the apparatus undergoes periodic inspection. Lint (lint balls 10) in the screen case 4 can be removed and discarded easily and quickly without necessitating any special skill or labor, whereas removing lint accumulated on a filter requires special skill and labor.

FIG. 2 (A) shows a cross-sectional view of the washing liquid supplying pipe 2 and the cylindrical screen 3 shown in FIG. 1. The washing liquid supplying pipe 2 and the cylindrical screen 3 are disposed coaxially with each other having a center axis represented by the Point O. Polar coordinates with the origin at point O are herein assumed. In the cross section made by a vertical plane passing through the origin O, the line extending radially vertically upward from the origin O is defined as the original line.

In the instant example, the peripheral wall 3a of the cylindrical screen 3 is rotated counterclockwise as indicated by the arrow a. The arrow b indicates the opposite direction to the rotating direction. The direction of arrow b is defined to be the positive direction of the polar angle. As shown in the Fig., polar angle increases from 0 degree to 90 degree, 180 degree, 270 degree, . . . , and finally returns to 0 degree (original line). The opening 2a shown in the FIG. 1 is located at a polar angle of 0 degree to 180 degree. When the cylindrical screen 3 is rotated clockwise, the polar angle is inversed. Despite the inversed polar angle, opening 2a is yet still located at a polar angle of 0 degree to 180 degree.

As described by the solid lines in FIG. 2 (B), the guide wing 6 in the instant example is formed in a convexly curved shape with the raised portion facing the inner peripheral wall 3a and having radius R. In another example, a straight guide wing 8 (described by the dashed lines) may be employed. The guide wing 6 or the straight guide wing 8 is preferably disposed at a polar angle of 0 degree to 180 degree. This guide wing functions to guide the flow of washing liquid to remove lint. For this purpose, the end of the guide wing are disposed close to the inner peripheral wall 3a. It is desirable, however, that the end of the guide wing does not contact with the inner peripheral wall to avoid generating friction resistance.

FIG. 2 (B) shows an embodiment other than the above embodiment. In the present embodiment, a concavely curved guide wing 9 is formed in a concavely curved shape with the raised portion facing opposite to the inner peripheral wall 3a. The concavely curved guide wing 9 is mounted at the same position as the above example (FIG. 2(A)).

### Second Embodiment

FIG. 3 shows a partially broken perspective view of the apparatus in an embodiment of the present invention. This Figure shows a typical view and does not show a realistic view. A cylindrical screen 11 is driven to rotate around its axis by driving rollers 18. In FIG. 3, the cylindrical screen 11 and the driving rollers 18 are movable members and other members are static members.

In the Figure, the right side end of the cylindrical screen 11 is made open and the left side end is covered. A screw conveyer 12 is disposed in the cylindrical screen. The right side end of the cylindrical screen (open end) functions as a lint outlet 16 (explained in detail below). The screw conveyer 12 having an axis 14 is coaxially fixedly mounted on a washing liquid supplying pipe 13. The reference numeral 7 indicates a washing liquid outlet. The axis 14 of the screw conveyer is fixedly supported by a screw bracket 15.

Although the right side end of the cylindrical screen 11 is an open end, the screw conveyer 12 accommodated therein prevents washing liquid let out from a washing liquid outlet 17 from flowing directly toward the open end and allows washing liquid to flow spirally along the screw conveyer 12, i.e. along the inner peripheral wall of the cylindrical screen 11. The peripheral wall of the cylindrical screen is made of filter, the detail of which will be below described with reference to FIG. 5. This allows most of washing liquid supplied into the cylindrical screen to cross the peripheral wall to be filter. Lint filtered off is accumulated on the inner peripheral wall of the cylindrical screen.

The cylindrical screen 11 is rotated in the direction of the arrow a by the driving rollers 18 and the accumulated lint is rotated along with the cylindrical screen 11, whereas the screw conveyer 12 is static. As a result of this, such an effect is obtained that the screw conveyer is rotated in the direction of the arrow a relative to the cylindrical screen so. Thus, the accumulated lint is scraped away to the right. The scraped lint is rolled in the cylindrical screen 11 to form lint balls 24, which is discharged through the lint outlet 16 as indicated by the arrow b.

FIG. 4 shows an embodiment other than the above embodiment. Elements different from those shown in FIG. 3 will be described below. A washing liquid diffuser plate 19 is disposed close to the washing liquid outlet 17 on the right side thereof, i.e. on the side of the open end of the cylindrical screen 11. The washing liquid outlet may be a circular plate disposed perpendicular to the axis X of the cylindrical screen. The washing liquid outlet may also be a member having a convex rounded surface (e.g. spherical surface) with the raised portion facing the open end (right side end) of the cylindrical screen. In both cases, the washing liquid diffuser plate 19 is required to have a diameter smaller than the inner diameter of the cylindrical screen.

The washing liquid diffuser plate 19 forces washing liquid let out from the washing liquid outlet 17 to move toward the inner peripheral wall of the cylindrical screen (functioning as a filter) to cross the inner wall and get filtered. By adopting this construction, it becomes possible to increase the flow rate per unit area of liquid passing through the inner wall functioning as a filter and, thus, the filtering efficiency is improved. This enables reducing the size and weight of the cylindrical screen while maintaining enough effect of lint removal.

FIG. 5 shows several variations of the above-described cylindrical screen. (A) represents an example in which a filter is formed by a single strand of wedge wire 20 tightly wound. (B) represents an example in which a filter is formed by many strands of wedge wires 21 wound in parallel. (C) represents an intermediate construction between the above two examples. The cross angle θ between the strands of the wedge wires and the circumferential direction of the cylindrical screen may be form 0 degree to 90 degree. Practically, however, the cross angle θ is preferably 0 degree<θ≦90 degree because it is extremely difficult to make the cross angle θ to be 0.

In the example (C), multiple strands of skew-wound wedge wires 22 is disposed on the right side (the side of the open end) of the outer peripheral wall of the cylindrical screen 11, excluding an area of the width L adjacent to the open end. (Referring also to FIG. 3 and FIG. 5(C)), washing liquid let out from the washing liquid outlet 17 flows spirally rightward along the screw conveyer 12 and gradually crosses the peripheral wall of the cylindrical screen 11. Thus, the amount of lint filtered gradually decreases as the washing liquid moves from left to right resulting in that substantially no lint is filtered in the vicinity of the open end (the right end) of the cylindrical screen (this phenomenon has been experimentally confirmed by the present inventors). On the basis of such findings, the right side area of the width L is not formed by filter and made impermeable in the example of FIG. 5(C). This construction results in reduction of manufacturing costs. The area of the width L is decided as follows. A plane S is assumed which passes through a point distant from the washing liquid outlet 17 toward the open end (the right end) at distance P and is perpendicular to the axis of the cylindrical screen 11. the area between the plane S and the open end, having width L, is decided to be the impermeable area.

The cylindrical screen 11 shown in FIG. 5(D) is formed of tiny pores 23 in stead of wedge wires. This construction results in reduction of manufacturing costs, while maintaining enough effect of lint removal.

### Third Embodiment

FIG. 6 is a partially broken perspective outline view typically showing the an embodiment of the lint removing apparatus according to the present invention. The reference numeral 31 indicates a conical-cylindrical screen, which is a principal member of the apparatus in the instant embodiment. This member is formed in a hollow conical shape having no bottom wall. The top part of the conical member is truncated and covered with a panel 39. In other words, this member is in the shape of a truncated corn having no bottom surface and has a peripheral wall formed of wedge filter 36. As described below, the bottom part having no wall functions as a lint outlet 32.

An outer rolling surface 34 is formed on the surface of the conical-cylindrical screen in the vicinity of the larger end and a pulley 35 is disposed in the vicinity of the larger end of the conical-cylindrical screen. It is preferable that the outer rolling surface 34 and the pulley 35 has substantially the same diameter. The outer rolling surface 34 and the pulley 35 are each contacted with driving rollers 33 so as to rotate the conical-cylindrical screen 31 by drive transmission. The direction of rotation may be either way.

A washing liquid supplying pipe 37 is disposed inside the conical-cylindrical screen 31 coaxially with the axial line X-X thereof, which penetrate through the panel 39. A washing liquid outlet 38 is formed near an end of the washing liquid supplying pipe 37. The washing liquid outlet is positioned on the side of the smaller end of the conical-cylindrical screen. A washing liquid diffuser plate 40 is disposed perpendicular to the X-X axis near the same end of the washing liquid supplying pipe 37. The periphery of the washing liquid diffuser plate 40 and the inner wall of the conical-cylindrical screen 31 is spaced away from each other. The washing liquid diffuser plate 40 is not necessarily required to have a disk-like form but may be of any form as long as it is capable of guiding the flow of the washing liquid let out from the washing liquid outlet 38 toward the edge filter 36.

Described below is operation and mechanism for removing lint off the washing liquid using the apparatus thus disclosed. The conical-cylindrical screen 1 is rotated by the driving roller 33 while supplying washing liquid from the washing liquid supplying pipe 37. The washing liquid supplied through the washing liquid outlet 38 is guided toward the wedge filter 36 by the washing liquid diffuser plate 40.

Washing liquid is cleared of lint when crossing the wedge filter 36. The lint filtered off accumulates on the inner peripheral wall of the wedge filter. In the vicinity of the inner peripheral wall of the wedge filter, complicated flows of washing liquid are generated, such as

a. flow from the washing liquid outlet 38 to the opening 32 on the bottom,
b. flow from the washing liquid outlet 38 passing through the wedge filter 36, and
c. rotating flow along with the rotation of the conical-cylindrical screen with washing liquid retained by the wedge filter 36.
These flows are mixed up to generate the spiral flow of washing liquid along the filter surface in the vicinity of the inner peripheral wall of the wedge filter.

Lint filtered by the wedge filter 36 is moved toward the bottom opening 32 on a spiral trajectory along the inner wall of the conical-cylindrical screen 31. Numerous pieces of lint are intertwined with each other to form lint balls. Ling balls moving spirally is subject to centrifugal force F away from the center X.

Because the inner peripheral wall of the conical-cylindrical screen 31 is of conical shape, component force F Sin θ is generated in the direction toward the opening 32 and parallel to the X axis. The lint balls are subject to the component force so as to roll on a spiral trajectory to reach the lint outlet 32 to be discharged therefrom as indicated by the arrow a. The reference numeral 46 indicates the discharged lint balls. Thus, lint contained in the washing liquid is automatically removed and discharged without necessitating cleaning by hand.

Various examples of conical-cylindrical screen is described below. FIG. 7(A) is a perspective outline view of the conical-cylindrical screen 31 shown in FIG. 6. Point P is defined on the peripheral wall. Circle S is defined as a sectional plane perpendicular to the X axis passing through point P. Line t-t is a tangent line of circle S at point P.

Line T-T represents the direction of the strand of the wedge filter 36 at point P. If angle φ made by the line T-T and the line t-t is very small, the wedge filter 36 will be that made of single long wedge wire tightly wound. However, it is not preferable to make φ to be 0 (it is possible to do so, but there is no cost advantage in doing so). Although not shown in the figures, if angle φ is made 90 degree, the wedge filter 36 will be that made of numerous wedge wires extending vertically upward. It is possible to do so, but, by doing so, it will be extremely difficult to regulate the wire pitch. In the present invention, the pitch angle φ may be from 0 to 90 degree.

FIG. 7(B) is a perspective outline view of an example of the conical-cylindrical screen 41 which is contrived so as to reduce the manufacturing costs by overcoming the technical problems of the wedge filter 36. A framed structure 42 of conical shape is formed to have a plurality of filter segments fitted inside openings delimited by the frames. In this framed structure, each filter segment 43 or other similar member can be supported by the framed structure 42 so as to form a conical-cylindrical screen 41 as a whole.

FIG. 7(C) is a perspective outline view of another example. This conical-cylindrical screen 44 is formed with numerous tiny pores 45. The conical-cylindrical screen 44 is manufactured by processing a punch plate to form a conical-cylindrical shape. By this construction also, it is capable of removing lint from washing liquid and making and discharging lint balls by utilizing centrifugal force.

### INDUSTRIAL APPLICABILITY

The device and method for removing lint according to the present invention can be suitably adapted to a large scale continuous washing machine used in laundry industry.

1. A lint removing apparatus comprising:
a washing liquid supplying pipe having an opening on the peripheral wall thereof;
a tubular screen disposed coaxially with said washing liquid supplying pipe so as to accommodate said washing liquid supplying pipe, said tubular screen being rotatable with respect to said washing liquid supplying pipe; and
a drive means to rotate said tubular screen.

2. The lint removing apparatus for a continuous washing machine as set forth in claim 1, wherein
said tubular screen is a cylindrical screen having a guide wing attached to said washing liquid supplying pipe adjacent to said opening, said guide wing having an end extending toward the inner peripheral wall of said cylindrical screen such that said end is disposed adjacent to the inner peripheral wall of said cylindrical screen;
said lint removing apparatus further comprising a screen case accommodating said cylindrical screen and communicated with a washing liquid collecting pipe.

3. The lint removing apparatus for a continuous washing machine as set forth in claim 2, wherein
said washing liquid supplying pipe is formed to be elongated in the axial direction of said cylindrical screen, and
the length of said opening in said axial direction is substantially same as the length of said cylindrical screen.

4. The lint removing apparatus for a continuous washing machine as set forth in claim 3, wherein
said washing liquid supplying pipe is a static member, and
said opening of said washing liquid supplying pipe is formed on the condition that:
a. when polar coordinates are assumed on the cross section of said washing liquid supplying pipe in which the polar angle of the vertically upward radius is defined as 0 degree,
b. the positive direction of the polar angle is defined to be opposite to the rotating direction of said cylindrical screen,
c. the polar angular position of said opening is from 0 degree to 180 degree.

5. The lint removing apparatus for a continuous washing machine as set forth in claim 4, wherein
said guide wing attached to said washing liquid supplying pipe is a static member, and
the polar angular position of the end of said guide wing is from 0 degree to 180 degree in said polar coordinates.

6. The lint removing apparatus for a continuous washing machine as set forth in claim 5, wherein
said cylindrical screen is formed in a substantially cylindrical shape and has a peripheral wall made of a porous plate, a wedge wire member or other similar member.

7. The lint removing apparatus for a continuous washing machine as set forth in claim 6, wherein
said cylindrical screen formed in a substantially cylindrical shape has an end wall made of a cover plate and another end wall having a lint outlet.

8. The lint removing apparatus for a continuous washing machine as set forth in claim 7, wherein
said cylindrical screen is inclined such that said lint outlet is disposed on the lower position.

9. The lint removing apparatus for a continuous washing machine as set forth in claim 1, wherein
a screw conveyer is disposed in said cylindrical screen.

10. The lint removing apparatus for a continuous washing machine as set forth in claim 9, wherein
said screw conveyer is mounted on said washing liquid supplying pipe in a coaxial position with respect to said washing liquid supplying pipe, and
a washing liquid outlet is formed in the vicinity of an end of said washing liquid supplying pipe.

11. The lint removing apparatus for a continuous washing machine as set forth in claim 10, wherein
said cylindrical screen has a peripheral wall formed with wedge wire, the cross angle between the strand of said wedge wire and the circumferential direction of said cylindrical screen being 0 degree<θ≦90 degree.

12. The lint removing apparatus for a continuous washing machine as set forth in claim 10, wherein
said cylindrical screen has a peripheral wall formed with numerous arranged minute pores.

13. The lint removing apparatus for a continuous washing machine as set forth in claim 12, wherein
said wedge wire or said minute pores are disposed on part of said cylindrical screen on the side of the end of said cylindrical screen accommodating said washing liquid supplying pipe, and
part of said cylindrical screen on the side of the open end thereof is impermeable, which is between said open end and a cross sectional plane S of said cylindrical screen at a distance P from said washing liquid outlet toward said open end.

14. The lint removing apparatus for a continuous washing machine as set forth in claim 11, wherein
said washing liquid supplying pipe is formed with a washing liquid diffuser plate in the vicinity of said washing liquid outlet and on the side closer to said open end of said cylindrical screen so as to diffuse washing liquid radially outward.

15. The lint removing apparatus for a continuous washing machine as set forth in claim 13, wherein
said washing liquid supplying pipe is formed with a washing liquid diffuser plate in the vicinity of said washing liquid outlet and on the side closer to said open end of said cylindrical screen so as to diffuse washing liquid radially outward.

16. The lint removing apparatus for a continuous washing machine as set forth in claim 1, wherein
said cylindrical screen is a conical-cylindrical screen formed in the shape of a conical cylinder having a peripheral wall made of filter and an open bottom end;
said lint removing apparatus further comprising
a drive means to rotate said conical-cylindrical screen and
a washing liquid supplying pore formed on the side of smaller end of said conical-cylindrical screen.

17. The lint removing apparatus for a continuous washing machine as set forth in claim 16, wherein
said conical-cylindrical screen is formed with a washing liquid diffuser plate substantially perpendicular thereto in a position closer to said bottom end relative to the position of said washing liquid supplying pore inside said conical-cylindrical screen.

18. The lint removing apparatus for a continuous washing machine as set forth in claim 17, wherein
said conical-cylindrical screen is formed in the shape of a truncated cone, said truncated top being covered with a panel,
said washing liquid supplying pipe is disposed to penetrate said panel so as to be rotatable relative to said panel, and
said washing liquid supplying pipe is formed with a washing liquid supplying pore on an end thereof.

19. The lint removing apparatus for a continuous washing machine as set forth in claim 17, wherein
said drive means to rotate said conical-cylindrical screen consists of an outer rolling surface on a larger end of said conical-cylindrical screen, a pulley having the same radius as said outer rolling surface disposed on a smaller end of said conical-cylindrical screen and driving rollers contacting with both said outer rolling surface and said pulley.

20. A method for removing lint from washing liquid comprising the steps of:
allowing washing liquid supplied by an washing liquid supplying pipe to be let out through an opening formed on the peripheral wall of said washing liquid supplying pipe;
introducing the washing liquid into the inside of a tubular screen accommodating said washing liquid supplying pipe such that lint is filtered off said washing liquid when crossing the peripheral wall of said tubular screen; and
recycling into a washing machine the clean washing liquid having lint filtered off by rotating said tubular screen with respect to the axis of said washing liquid supplying pipe.

21. The method for removing lint from washing liquid for a continuous washing machine as set forth in claim 19, wherein
said tubular screen is a cylindrical screen, and
lint collected on the inner peripheral wall of said cylindrical screen is automatically removed by liquid flow generated by a guide wing mounted on said washing liquid supplying pipe.

22. The method for removing lint from washing liquid for a continuous washing machine as set forth in claim 21, wherein
said cylindrical screen is disposed to be inclined such that lint removed by said liquid flow is moved to the lower side thereof so as to be discharged through a lint outlet formed on the lower side end of said cylindrical screen.

23. The method for removing lint from washing liquid as set forth in claim 20, wherein
said tubular screen is a cylindrical screen having an open end and a screw conveyer therein, and
lint collected on the inner peripheral wall of said cylindrical screen is discharged through the open end thereof by
allowing washing liquid to be let out in said cylindrical screen in the vicinity of the other end than said open end thereof,
allowing washing liquid to cross the peripheral wall of said cylindrical screen such that lint is filtered off the washing liquid, and
rotating said cylindrical screen around the axis thereof to cause said screw conveyer to convey said collected lint toward the open end of said cylindrical screen.

24. The method for removing lint from washing liquid as set forth in claim 23, wherein
a washing liquid diffuser plate is disposed in the vicinity of the washing liquid outlet inside said cylindrical screen so as to diffuse the washing liquid let out into said cylindrical screen in radially outward direction of said cylindrical screen.

25. The method for removing lint from washing liquid as set forth in claim 24, wherein
said cylindrical screen is at least partially formed with wedge wire and permeable, and
the cross angle between the strand of said wedge wire and the circumferential direction of said cylindrical screen being 0 degree<θ≦90 degree,
or wherein
the peripheral wall of said cylindrical screen is at least partially formed with minute pores so as to function as a permeable filter, and
part of said cylindrical screen on the side closer to the open end thereof is not formed with wedge wire or pores and is impermeable, which is between said open end and a cross sectional plane S of said cylindrical screen at a distance P from said washing liquid outlet toward said open end.

26. The method for removing lint from washing liquid as set forth in claim 20, wherein
said cylindrical screen is a conical-cylindrical screen having an open bottom end, and
lint is automatically discharged through said open bottom end thereof by supplying washing liquid to the side of the top of the corn of said conical-cylindrical screen with said conical-cylindrical screen being rotated around the axis X thereof so as to cause the supplied washing liquid to flow in the rotating direction and to be centrifugally forced to cross through the peripheral wall of said conical-cylindrical screen with the lint filtered off, the filtered lint collected on the inner peripheral wall of said conical-cylindrical screen being centrifugally forced to move toward the bottom end thereof.

27. The method for removing lint from washing liquid as set forth in claim 26, wherein
a washing liquid diffuser plate is disposed in a position closer to said bottom end relative to the position of the washing liquid supplying opening inside said conical-cylindrical screen so as to diffuse the washing liquid toward the inner peripheral wall of said conical-cylindrical screen.

28. The method for removing lint from washing liquid as set forth in claim 27, wherein
said conical-cylindrical screen is formed with an outer rolling surface on the larger end thereof to be contacted with driving rollers and a pulley having the same radius as said outer rolling surface on the smaller thereof to be contacted with said driving rollers such that said conical-cylindrical screen is driven to rotate.

29. The method for removing lint from washing liquid as set forth in claim 28, wherein
the peripheral wall of said conical-cylindrical screen is formed with wedge filter, and the angle φ made by the wedge wire of said wedge filter and the circumference passing through a point P on the peripheral surface of said conical-cylindrical screen is 0 degree≦φ<90 degree,
or wherein
the peripheral wall of said conical-cylindrical screen is formed with numerous minute pores.
